(19) United States
(12) Patent Application Publication
(10) Pub. No.: US 2008/0020794 A1
(43) Pub. Date: Jan. 24, 2008

(54) MOBILE ELECTRONIC DEVICE WITH FLUID DELIVERY SYSTEM

(76) Inventors: Mark GARON, Saint-Hyacinthe (CA); David Drapeau-Garon, Saint-Hyacinthe (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/738,735

(22) Filed: Apr. 23, 2007

Related U.S. Application Data
(63) Continuation of application No. PCT/CA05/01624, filed on Oct. 21, 2005.
(60) Provisional application No. 60/620,686, filed on Oct. 22, 2004.

(51) Int. Cl. H04M 1/00

(52) U.S. Cl. 455/556.1; 128/200.14; 600/365; 604/36

(57) ABSTRACT

A portable electronic device comprising an outer casing having at least one electrical component and a fluid delivery system therein. The fluid delivery system is integrally defined within at least a portion of the outer casing. The fluid delivery system includes an internal reservoir defined within the outer casing and within which a fluid is contained. The fluid delivery system is operable to dispense the fluid from the portable electronic device. Preferably, the fluid delivery system is an aerosol delivery system which dispenses an aerosol product.

### CROSS-REFERENCE TO RELATED APPLICATIONS

The present application is a continuation of International Patent Application No. PCT/CA2005/001624 filed Oct. 21, 2005, which itself claims priority on U.S. Provisional Patent Application No. 60/620,686 filed Oct. 22, 2004, the entire contents of both of which are incorporated herein by reference.

### TECHNICAL FIELD

The invention relates generally to a portable electronic device having a fluid delivery system incorporated therein. More particularly, the present invention relates to an aerosol delivery system operable to supply a dose of an aerosol product to a user, and, more specifically, to an aerosol delivery system integrated into a mobile electronic device.

### BACKGROUND OF THE ART

Aerosols are commonly used for the delivery of a variety of substances, such as perfumes, repellents, breath fresheners, and drugs which may be administered in aerosolized form. The administration of such substances is often required or desired at any time, and therefore requires a user to carry the aerosol delivery device used to dispense such agents whenever and wherever may be necessary. Such portable aerosol delivery systems include medicinal inhalers used for the treatment of conditions such as asthma. However, such commonly used aerosol inhalers are, however, relatively bulky.

Further, with portable electronic devices having become increasingly popular of late, a significant percentage of consumers already carry around at least one mobile electronic device, such as, for example, a mobile telephone, a mobile personal computer (PC), a personal digital assistant (PDA), a digital camera or a portable music player. As the market for mobile phones has reached huge proportions, it follows that a not insignificant group of the users which own a mobile phone, also require or use aerosol dispensing devices of some sort. For the users of this market segment, the additional burden of transporting an aerosol inhaler or dispenser used for either medicinal or cosmetic purposes, for example, as well as any number of such portable electronic devices, becomes unduly onerous.

The highly competitive field of mobile telephones and PDAs has already expanded to integrate several of such electronic devices into a single portable unit. However, to date little integration of one such mobile electronic device with a medicinal, cosmetic or hygienic delivery system has been attempted.

Relatively small scale wearable aerosol delivery devices are known, for example in the form of a wrist-worn device as described in U.S. Pat. No. 6,223,744 which issued May 1, 2001, the contents of which are incorporated herein by reference. However, while such a delivery device is small and portable, it fails to take advantage of the growing number of portable electronic devices which users have since adopted in such large numbers.

### SUMMARY OF THE INVENTION

It is therefore an object of this invention to provide an improved portable aerosol delivery system.

It is another object of the present invention to provide a mobile electronic device having fluid dispensing capability.

In one aspect, the present invention provides a portable electronic device comprising an outer casing having at least one electrical component and a fluid delivery system therein, said fluid delivery system being integrally defined within at least a portion of the outer casing, said fluid delivery system including an internal reservoir defined within said outer casing and within which a fluid is contained, said fluid delivery system being operable to dispense said fluid from said portable electronic device.

In another aspect, the present invention provides a portable multiple utility device comprising: a mobile electronic device having an outer casing and an electrical component therein; and an aerosol delivery system integrated within said electronic device, said aerosol delivery system comprising: a reservoir for receiving an aerosol product; an outlet nozzle through which the aerosol product is releasable; and an actuating valve operable to release said aerosol product from said outlet nozzle.

In another aspect, the present invention provides a mobile telephone having an outer casing with a fluid delivery system integrated therein, the fluid delivery system having an internal reservoir defined within said outer casing and within which an fluid product is contained, the fluid delivery system having an actuator operable to dispense said fluid product from said mobile telephone.

In accordance with the present invention, there is also provided a portable aerosol delivery device comprising: an outer housing defining therein an internal reservoir containing an aerosol product, the outer housing having a configuration corresponding to a removable rear casing of a mobile electronic device, said outer housing being adapted to selectively replace said rear casing; an outlet nozzle in fluid flow communication with said reservoir via a flow control valve; and a valve actuator operable to open and close said flow control valve to dispense said aerosol product from said outlet nozzle.

There is further provided, in accordance with the present invention, a kit comprising: a mobile electronic device having an outer casing with a removable portion thereof; and an aerosol delivery system having an internal reservoir within which an aerosol product is contained and an outlet nozzle through which said aerosol product is dispensable, an externally accessible valve actuator being operable by a user to dispense said aerosol product from said outlet nozzle; and said aerosol delivery system being removably engageable to said mobile electronic device in replacement of said removable portion of said outer casing.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a front perspective view of a mobile telephone having a manually activated aerosol delivery system integrated therewith in accordance with the present invention;

FIG. 2 is a rear perspective view of the mobile telephone of FIG. 1;

FIG. 3 is a rear perspective view of the mobile telephone of FIG. 2 with the aerosol delivery system portion removed;

FIG. 4 is an exploded side elevation view of the mobile telephone and aerosol delivery system of FIG. 3;

FIG. 5 is a rear perspective view of a mobile telephone having an integrated solenoid activated aerosol system in accordance with another embodiment of the present invention; and

FIG. 6 is a front elevation view of a portable electronic device in accordance with an alternate embodiment of the present invention, which includes at least a glucose meter.

### DETAILED DESCRIPTION OF THE PREFERRED EMBODIMENTS

The present invention comprises generally a fluid delivery system incorporated with a mobile electronic device, such as a mobile telephone, personal digital assistant (PDA) or the like. Although attempts have been made to combine or integrate several consumer electronic devices into a single mobile unit in order to reduce the number and size of items which are required to be carried around by users, the present invention integrates a fluid dispenser into a mobile electronic device, such that one a single portable unit must be carried by the user. Such a portable multiple utility device would eliminate the necessity to carry a stand alone fluid dispensing device which may also be commonly transported, such as aerosol based asthma pumps, breath fresheners, perfume dispensers, for example. Additionally, as the after market industry for personalizing mobile phones and other mobile electronic devices continues to grow, the desire for new functionalities which can be integrated into an existing mobile phone as an after market upgrade will also increase.

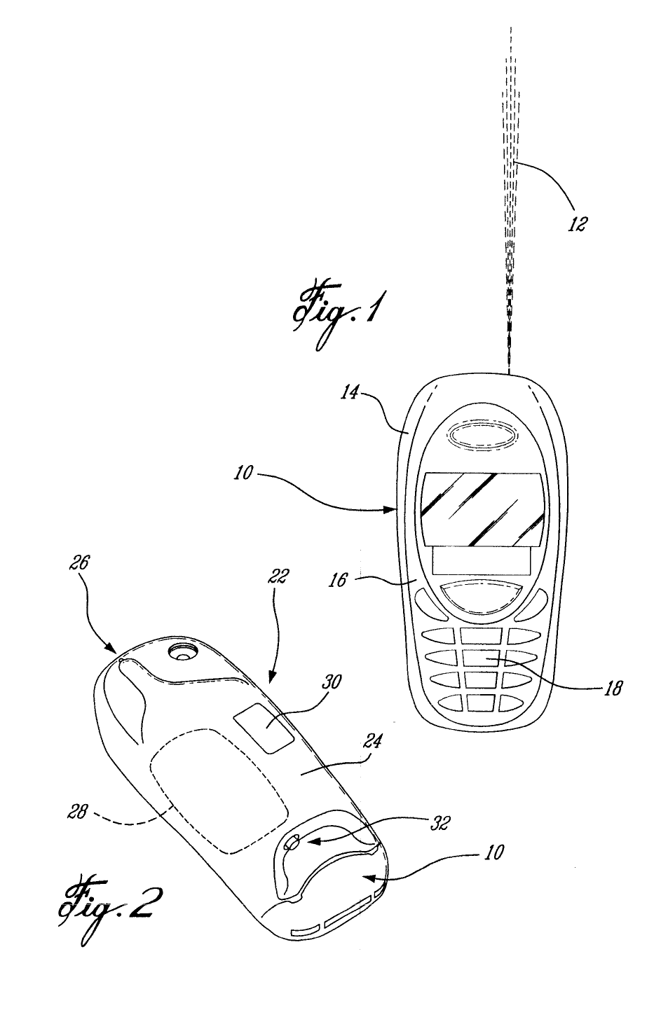

Referring to FIG. 1, a mobile telephone 10 which comprises a fluid delivery system integrated therein is shown in use, ejecting a fine mist or spray 12 of an aerosol product contained therein. Although the embodiment of the present invention is generally described below with particular reference to an aerosol fluid and thus an aerosol delivery system, other types of fluid can similarly be dispensed by the portable electronic device of the present invention. Thus, if an non-aerosol fluid is contained within the device for dispensing, the fluid can be atomized for sprayed ejection therefrom using a pump in communication with both the fluid reservoir and the ejection nozzle, whether the pump is manually actuated (such as for a hand or finger pump) or is alternately electrically driven (and as such powered by the battery of the electronic device for example).

The mobile telephone 10 includes an outer casing 14 within which the electronic components of the phone are contained. The outer casing 14 has, on its front side, a face plate portion 16 through which the buttons 18 of the phone project. The aerosol delivery system 22 of the present invention is preferably mounted to the rear side of the mobile telephone 10, as is more clearly seen in FIG. 2. The portion of the outer casing 14 which enclosed the aerosol delivery system 22 comprises a rear housing 24 having a configuration which generally corresponds to a standard removable rear face plate or rear casing portion of the telephone, such that the rear housing 24 replaces the standard rear casing or rear face plate of the phone, thereby integrating the aerosol delivery system with the mobile telephone. As it will be described, the aerosol delivery system 22 can either be fully integrated within the outer casing of the mobile phone from initial design, or can be added to the phone in replacement of the standard rear face plate which typically provides access the phone's battery. In this case, the rear housing 24 of the aerosol delivery system 22 in fact fully encloses the system, and is configured to correspond to the shape of the standard phone's rear face plate such that it can be engaged to the phone to enclose the rear portion. Within the outer housing 24 of the aerosol delivery system is defined an internal reservoir 28 within which an aerosol product is contained. The term “aerosol product” as employed herein is intended to include aerosols in their larger sense, therefore comprising fine powders, a pure liquid, a solution, and emulsion, precipitates, a gel, a foam product or any number of combinations thereof. This aerosol product is pressurized within the reservoir 28, either by a gaseous propellant or by mechanical pumping, such that the pressure gradient between atmosphere and the inside of the reservoir is sufficient to propel the active ingredient out of the reservoir. Such mechanical pumping is achieved either using a powered pump (for example a small electrical pump driven by the power supply of the electrical device) or alternately using a manual pump mechanism which is manually actuable by a user (such as a hand or finger pump for example).

The aerosol delivery system 22 includes an outlet nozzle 26 disposed at an upper end thereof, through which the aerosol product is dispensable. The outlet nozzle 26 is in fluid flow communication with the reservoir 28, preferably via a valve or flow controlling means which selectively permits dispensing the aerosol product when desired. In one embodiment of the aerosol delivery system 22, a push button actuator 30 is manually operable by the finger's of a user to open and close the internal valve linking the reservoir 28 with the outlet nozzle 26, such that when a user depresses the push button actuator 30 the valve is opened and aerosol product is permitted to flow from the pressurized reservoir 28 to the outlet nozzle 26, and therefore dispensed by spraying out into the surrounding air from the outlet nozzle. It is to be understood that the outlet nozzle 26 can be designed to provide any of a number of spray types depending on the particular application. For example, the amount of product dispensed and density of the ejected flow (ie: stream vs. wide spray) will depend on the application. A perfume dispenser, for example, requires different flow characteristics than an asthma medicament inhaler. The aerosol delivery system 22 further includes an inlet port 32 which acts as a fill valve such that the reservoir 28 can be refilled when it has been emptied. However, in the embodiment described below in which the reservoir 28 itself is removable from the rest of the aerosol delivery system for refilling or replacement, such an external fill valve/inlet port 32 may not be required. The manually actuated button 30 is preferably disposed such that it is within easy reach of a finger of a user holding the mobile telephone 10 in a normal operating position.

Many applications exist for such an aerosol delivery system 22 which is integrated within a portable electronic device such as a mobile telephone 10. Some examples of possible uses for a portable aerosol delivery system include: the dispensing of inhaled or ingested medicaments for treatment of such conditions as asthma, allergies and the like; for security or safety reasons, such as wherein the spray of a repellent such as pepper spray or mace is used for protection; and for cosmetic or hygienic reasons, such as to dispense a dose of perfume, cologne or a breath freshener. By integrating the portable aerosol delivery system 22 into, or with, an electronic device, a plurality of possibilities exist for inter-operability of the aerosol delivery system and the electronics of the device. For example, as will be described in further detail below, by providing an electrically operated solenoid into the aerosol delivery system 22, the programmable electronics of the mobile phone 10 or other similar electronic device can be used to activate the solenoid, and therefore dispense the aerosol product therefrom. Some possible examples of such applications include: remote actuation of the aerosol dispenser; initiating a phone call upon actuation of the aerosol delivery device, or conversely, actuating the aerosol delivery device upon receipt/sending of a phone call or other electronic function; and automatic actuated dispensing of the aerosol product based on input signals received by the electronic device from sensors provided thereon. Another possible use of the present invention includes incorporating a lighter into the mobile phone, by providing butane or a similarly combustible material within the reservoir which itself acts as the active ingredient, and may be ignited by mechanical or electromechanical parts powered and operated by the telephone or PDA.

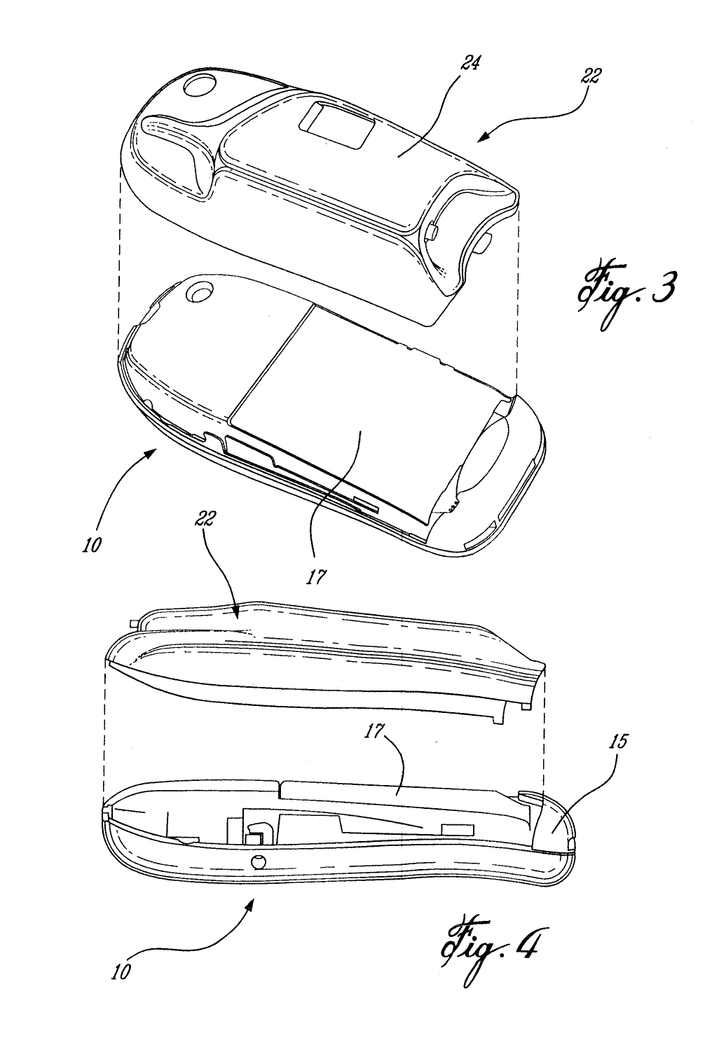

The aerosol delivery system 22 may be completely removable from the mobile telephone 10 as depicted in FIGS. 3 and 4. As depicted, with a standard back plate of the phone removed, which is possible to provide access to the battery 17, the housing 24 of the aerosol delivery system 22 can be engaged to the phone in its place. As shown in FIG. 4, the rear plate release member 15 of the phone is depressed, allowing the aerosol delivery system to be positioned in place, and retained therein. Thus, the housing 24 replaces the standard phone rear face plate, creating an outer casing assembly for the phone which is smoothly integrated. Provided the size of the reservoir is kept to a reasonable size, the aerosol delivery system 22 only adds a relatively small amount of total thickness and weight to the phone. However, the aerosol delivery system 22 may also be completely integrated within the outer casing 14 of the mobile telephone or electronic device. In this case, the aerosol delivery system is designed to be disposed within the electronic device and it is therefore fully integrated therein. However, by having a removably engageable aerosol delivery system as depicted in FIGS. 3 and 4, any standard removable rear face plate of the mobile phone or PDA can be removed and the aerosol delivery system replaces such a standard rear cover, thereby permitting the possibility of retrofitting existing designs of mobile electronic devices.

The internal reservoir 28 is preferably integrated within the outer housing 24 of the aerosol delivery system 22. However, the reservoir 28 itself may be removable from the rest of the aerosol delivery system 22, such that the reservoir can be replaced or repaired in case of damage and such that an empty reservoir can be removed from the assembled or integrated phone and aerosol delivery system, and replaced with a full one without having to refill the reservoir in situ within the phone/aerosol delivery system assembly. The aerosol delivery system 22 may also be designed to accept standard small aerosol cans which are commercially available, allowing such standard cans to be inserted into position within the outer housing 24 of the aerosol delivery system 22 to provide the removable reservoir.

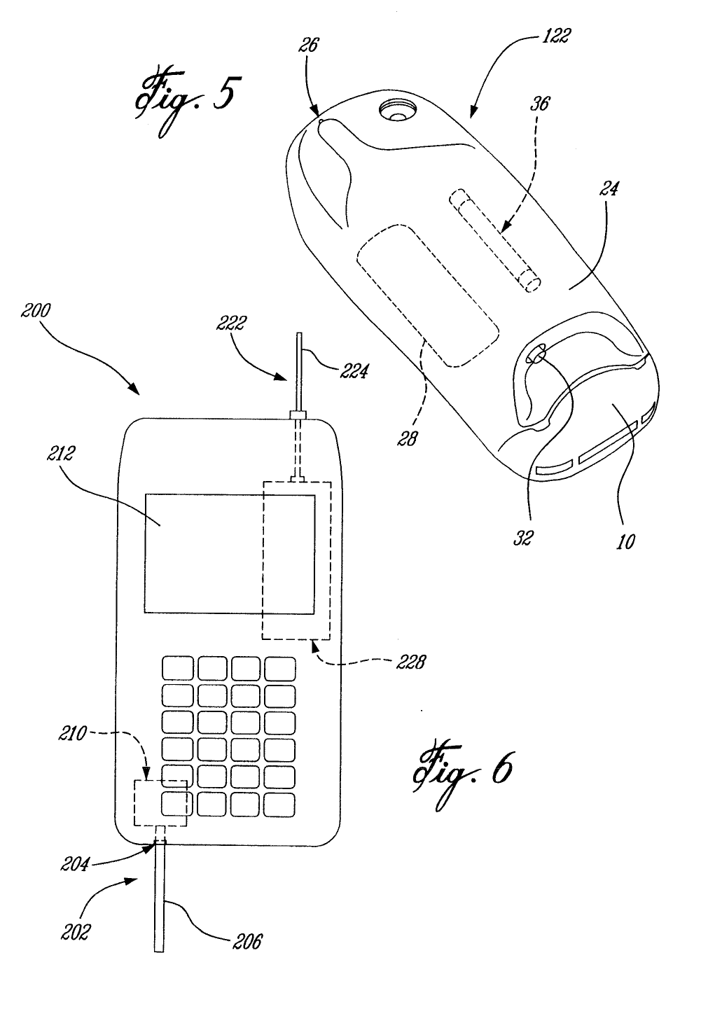

Referring now to FIG. 5, the aerosol delivery system 122 of an alternate embodiment is similar to the aerosol delivery system 22 in most respects, however includes an electric actuator 36 for controlling the delivery of aerosol product. This can either be in lieu of the manual push button actuator 30 of the aerosol delivery system 22, or as well as. The electric actuator 36 is preferably an electric solenoid valve, in the case of a gaseous aerosol, or a linear actuator, to activate an internal pump disposed within the outer housing 24 in the case of a liquid aerosol. This embodiment can be particularly advantageous as the electric actuator 36 can be electronically controlled, as described above, and related to specific programmable functions in conjunction with a mobile electronic device such as the mobile telephone 10. The rechargeable battery of the mobile telephone is used to power the solenoid valve or linear actuator which makes up the electric actuator 36 of the aerosol delivery system 122. Alternately, if the needs of the particular application require very frequent use or increased power requirements, a separate independent battery solely for the electric actuator 36 is provided within the outer housing 24 of the aerosol delivery system 122. As today's mobile electronic devices have become increasingly sophisticated, the memory and processing power of these devices are able to operate the aerosol delivery system 122, such that it is electronically controlled and programmed to dispense aerosol product in response to inputs provided from the electronic device. For example, the electric actuator 36 can be activated in response to an incoming phone call on the mobile telephone 10, such that a fragrance is dispensed from the phone to indicate the incoming call in lieu of an audible ring or vibration. Additionally, external sensors may be provided on the aerosol delivery system 122 in order to detect a number of given atmospheric characteristics. Such electronic control of the dispensed aerosol product from the aerosol delivery system 122 also permits the blocking of attempted manual actuation, to prevent any possible abuse of an active ingredient, such as, for example, a medicinal aerosol product. Another example of a use of the aerosol delivery system 122 incorporated with a mobile telephone or other electronic device is the use of an active ingredient which is indicative of an emergency situation, such as the use of epinephrine to treat the presence of an allergic reaction in a user. As such an allergic reaction or the sudden treatment of an active ingredient could result in the incapacitation of the user, the mobile telephone integrated with the aerosol delivery system 22,122 may be programmed to automatically dial up a selected party, such as emergency response, when actuation of the spray is detected. Another example in which an automatic dial up feature is activated in response to dispensing of the aerosol product, includes the use of a self protection product such as pepper spray or mace. In such a situation, upon manual actuation by the user, in either the aerosol delivery system 22 or 122, “911” or a similar emergency response are automatically called. The electronic device may then be located through the use of an inbuilt global positioning system, or simply by tracking the source location of the telephone signal.

As many of today's mobile electronic devices allow the use of independent software which can be uploaded to the device, many other possibilities exist for incorporating individual programming of the electronic device with dispensing of an aerosol product contained within an aerosol delivery system mounted within the mobile electronic device.

Another application and embodiment of the present invention is as a mobile electronic device 200 with a built-in glucose meter, as depicted in FIG. 6, either with or without an additional insulin dispenser. As the number of people who have diabetes continues to grow, the need for portable, reliable and accurate devices for measuring blood glucose levels and for administrating insulin to the user increases. As such, electronic devices such as digital glucose meters have become more commonplace, however have to be separately transported by users, as well as any number of other mobile electronic and telecommunication devices. The portable electronic device 200 of the present invention configured to comprise a glucose meter includes a means for sampling 202, which includes a blood sample inlet such as a receiving port 204 and/or alternatively a testing needle 206 for example in addition to a storage element such as a reservoir for the collected blood, and a means for analysis 210 which is capable of analyzing the blood sample and determining a level of glucose in the sampled blood. Thus, the means for sampling 202 and the means for analysis 210 make up a fluid receiving/testing system is included with, preferably integrally, the portable electronic device. A reservoir within the device, is thus used to store the sampled blood, and a suitable means for draining this reservoir is also provided. The results of the measured blood sugar level may then be communicated to the electronics of the mobile phone or similar device, and displayed on the visual display 212 thereof. At least part of the analysis and testing means of such a glucose meter may be incorporated into the circuitry of the mobile phone, such that only a single portable device need be transported by the user. Thus, this application of the present invention incorporates a glucose meter directly into the mobile electronic device 200. The portable electronic device 200, in addition to the glucose meter as described above, can also include a fluid delivery system 22 aerosol or otherwise) as described above with regards to the embodiment of FIG. 1.

The portable electronic device 200 may also include an integrated insulin delivery system 222 incorporated therein, which provides insulin for emergency injection by the user to control a potentially dangerous drop in blood sugar levels. Particularly, such a system permits the dispensing of insulin directly from the mobile device incorporated in the mobile phone or the like. As for this application the insulin must be administered via a syringe, the fluid delivery system 222 of this embodiment of the present invention includes a small needle or syringe 224 in fluid flow communication with the internal reservoir 228 which contains insulin therein, and which may be manually actuated by the user to project from the casing when necessary. The small syringe 224 is preferably spring biased, such that upon release due to user actuation, it springs out from the outer casing of the device in a deployed mode ready for injecting the user in an emergency situation. Clearly, a safety mechanism is provided to prevent unwanted deployment of the dispensing syringe. In FIG. 6, the syringe 224 is show as extending, when in a deployed position, from the upper end of the electronic device 200, however the syringe 224 can equally project from elsewhere, such as the bottom end thereof where the sampling means 202 of the glucose meter portion of the device may be located. Further, although the testing needle 206 of the glucose meter and the insulin delivery syringe 224 of the fluid dispensing device are depicted in FIG. 6 as separate elements, it is to be understood that a single needle/syringe which is capable of both functions (i.e. for drawing blood for testing of blood sugar level, and subsequently for delivering insulin to the user) can alternately be used.

The above description is meant to be exemplary only, and one skilled in the art will recognize that changes may be made to the embodiments described without department from the scope of the invention disclosed. For example, although the present invention is generally described above with reference to a mobile telephone, it is to be understood that other mobile electronic devices can similarly be used in conjunction with the aerosol delivery system of the present invention. Similarly, although the present invention has been described with reference specifically to aerosol systems, the scope of the present invention also includes a fluid delivery system, which may not be an aerosol, within a mobile electronic device. Still other modifications which fall within the scope of the present invention will be apparent to those skilled in the art, in light of a review of this disclosure, and such modifications are intended to fall within the appended claims.

1. A portable electronic device comprising an outer casing having at least one electrical component and a fluid delivery system therein, said fluid delivery system being integrally defined within at least a portion of the outer casing, said fluid delivery system including an internal reservoir defined within said outer casing and within which a fluid is contained, said fluid delivery system being operable to dispense said fluid from said portable electronic device, wherein said fluid delivery system is removable from said portable electronic device and includes an outer housing defining at least said reservoir therein, said outer housing having a configuration corresponding to a removable rear casing portion of the portable electronic device, said outer housing being adapted to replace said rear casing portion to integrate said fluid delivery system with said portable electronic device.

2. The portable electronic device as defined in claim 1, wherein said fluid delivery system is an aerosol delivery system, and said fluid is an aerosol product.

3. The portable electronic device as defined in claim 1, wherein said fluid delivery system includes an outlet nozzle through which said fluid is dispensed, said outlet nozzle being in fluid flow communication with said reservoir.

4. The portable electronic device as defined in claim 3, wherein the fluid delivery system includes an actuator operable to dispense said fluid from said outlet nozzle.

5. The portable electronic device as defined in claim 1, wherein the portable electronic device is one of a mobile telephone, a personal digital assistant (PDA) and a mobile personal computer (PC).

6. The portable electronic device as defined in claim 1, further comprising an inlet port disposed through said outer casing and being in fluid flow communication with said reservoir, such that said reservoir is refillable when empty.

7. The portable electronic device as defined in claim 4, wherein said actuator is a manually operated actuator externally accessible by a user holding said portable electronic device.

8. The portable electronic device as defined in claim 7, wherein said actuator includes a pumping mechanism, said pumping mechanism being at least one of manually operated by a user and operated by a power supply.

9. The portable electronic device as defined in claim 8, wherein said pumping mechanism includes a manually operated hand-operated pump.

10. The portable electronic device as defined in claim 8, wherein said pumping mechanism includes an electrical pump driven by the power supply of said electronic device.

11. The portable electronic device as defined in claim 7, wherein said actuator is operable open and close a valve disposed between said outlet nozzle and said reservoir, such that fluid is dispensed from said outlet nozzle when valve is in an open position.

12. The portable electronic device as defined in claim 11, wherein said actuator is an electric solenoid.

13. The portable electronic device as defined in claim 12, wherein said electrical solenoid is in electric communication with a power supply of said portable electronic device.

14. The portable electronic device as defined in claim 12, wherein said portable electronic device is programmable to dispense said fluid based on at least one predetermined selection criteria.

15. The portable electronic device as defined in claim 1, wherein said internal reservoir is removable from the outer casing.

16. The portable electronic device as defined in claim 15, wherein said removable internal reservoir is a disposable aerosol canister.

17. A portable electronic device comprising an outer casing having at least one electrical component and an aerosol delivery system therein, said at least one electrical component being operable to perform at least one function unrelated to aerosol delivery, said aerosol delivery system being integrally defined within at least a portion of the outer casing and including an internal reservoir defined in said outer casing within which an aerosol product is contained, said aerosol delivery system being operable to dispense said aerosol product from said portable electronic device, and wherein said aerosol delivery system comprises a glucose meter for measuring blood sugar level of a user.

18. The portable electronic device as defined in claim 17, wherein said glucose meter includes means for sampling blood of the user and means for analysis to determine said blood sugar level, said determined blood sugar level being displayed to the user.

19. The portable electronic device as defined in claim 17, further comprising an insulin delivery system providing insulin for injection by the user.

20. The portable electronic device as defined in claim 19, wherein said insulin delivery system includes a syringe selectively extendable from the device for injection of said insulin.

21. A portable aerosol delivery device comprising:
an outer housing defining therein an internal reservoir containing an aerosol product, the outer housing having a configuration corresponding to a removable rear casing of a mobile electronic device, said outer housing being adapted to selectively replace said rear casing;
an outlet nozzle in fluid flow communication with said reservoir via a flow control valve; and
a valve actuator operable to open and close said flow control valve to dispense said aerosol product from said outlet nozzle.

22. The portable aerosol delivery device as defined in claim 21, wherein said reservoir is removable from the outer housing.

23. The portable aerosol delivery device as defined in claim 21, wherein an inlet port disposed through said outer housing is in fluid flow communication with said reservoir, such that said reservoir is refillable via said inlet port when empty.

24. A kit comprising:
a mobile electronic device having an outer casing with a removable portion thereof; and
an aerosol delivery system having an internal reservoir within which an aerosol product is contained and an outlet nozzle through which said aerosol product is dispensable, an externally accessible valve actuator being operable by a user to dispense said aerosol product from said outlet nozzle; and
said aerosol delivery system being removably engageable to said mobile electronic device in replacement of said removable portion of said outer casing.
